(19) United States
(12) Patent Application Publication
(10) Pub. No.: US 2005/0240780 A1
(43) Pub. Date: Oct. 27, 2005

(54) Self-propagating program detector apparatus, method, signals and medium

(75) Inventor: Gary Lorne MacIsaac, Vancouver (CA)

Correspondence Address: KLARQUIST SPARKMAN LLP, 121 S.W. SALMON STREET, SUITE 1600, PORTLAND, OR, 97204, US

(73) Assignee: Cetacea Networks Corporation

(21) Appl. No.: 10/831,566

(22) Filed: Apr. 23, 2004

(51) Int. Cl. G06F 11/30

(52) U.S. Cl. 713/188

(57) ABSTRACT

A method, apparatus, signals and medium for detecting self propagation of a self-propagating program involves producing difference values, each difference value representing a difference between volume of data traffic transmitted in a transmit direction and volume of data traffic received in a receive direction, in successive periods of time, incrementing an anomaly event counter when one of the difference values satisfies a difference criterion and setting an indicator active when the anomaly event counter reaches a value that meets a count criterion.

### BACKGROUND OF THE INVENTION

1. Field of Invention

This invention relates generally to computer networks and security, network abuse associated with self-propagating viruses and more particularly to a self-propagating program detector apparatus, method, signals and medium.

2. Description of Related Art

The rapid expansion of high-speed personal Internet connections and the use of the World Wide Web for commerce, entertainment and education provides significant benefits to the global user community. The wide-spread, low cost and continuous availability of web-based information services has resulted in developments ranging from new business models to portals which provide access to government and education services, to the rapid and free exchange of ideas and information for all members of the Internet community.

Because the Internet is so widely available to the public it is vulnerable to being disrupted by various malicious exploits of network protocol behaviours which are fundamental to the operation of the Internet. The malicious exploits include the creation and dissemination of rapidly % propagating computer viruses and worms which target particular operating systems or applications, abuses of network protocol features such as packet broadcasting and TCP/IP connection establishment, and intrusions into network-connected computer systems.

The perpetrators of such malicious exploits often take advantage of computer operating system flaws or use “social engineering” techniques to trick users into activating trojan software on computer systems and basic human errors in system configuration such as poor choices for access control passwords. Other modes of compromise may be via email worms that use attachments which, when activated by the user, open a communication path on the infected computer that is accessible to a remote attacker. System administrators and users can attempt to minimize the vulnerabilities of their computer systems by changing procedures (e.g. using stronger passwords or deleting suspicious email messages and attachments), applying software patches, and the like. Keeping computer systems secure is an ongoing task. It is inevitable that software bugs will continue to appear, user configuration errors will be made and attackers will uncover previously unknown weaknesses in systems or will modify current attack software in new ways.

Even secure computer systems are vulnerable to having their Internet connectivity disrupted. One type of malicious Internet activity, which can produce significant disruption to users of Internet web sites, Domain Name Servers and/or core routers, includes self-propagating viruses which can be very difficult to prevent because they make use of functions which are fundamental to the operation of the Internet itself.

Self-propagating viruses involve the unauthorized receipt and installation of drone software agents on computers, which may number in the tens, hundreds or even thousands. These viruses may cause compromised computer systems generate massive amounts of scanning packet flood traffic addressed to random or semi-random Internet Protocol addresses in an attempt to infect new, vulnerable host computers. As these programs spread, they flood the Internet infrastructure (routers and high-speed links) with massive numbers of these random or semi-randomly addressed packets. The packets may be addressed to a plurality of target systems. The packets may comprise, for example, continuous streams of Transmission Control Protocol (TCP), User Datagram Protocol (UDP) and/or Internet Control Message Protocol (ICMP) packets all directed at different or the same target system. These protocols are implemented at the Internet layer and the transport layer which are described in Internet Engineering Task Force (“IETF”) RFC Standard 1122 and related RFC documents.

Detecting when an unusual number of outgoing packets is generated by a compromised computer can be difficult. Often an unusual increase in outgoing packets can last for an extended period of time making the compromised computer unavailable for the duration of the period.

Virus intrusion can be very difficult to trace. In almost all cases, the source Internet Protocol (IP) addresses found in the viral packets have been spoofed, that is altered to a false value, thereby providing no information about the true identity of the originating systems.

There exist some systems which may provide some means for identifying signatures of known drone agents and/or limiting the ability of drones to spoof the source address of packets used in attacks. Packet filtering firewalls such as described, for example, in U.S. Pat. No. 5,606,668 issued Feb. 25, 1997 and entitled “System for Securing Inbound and Outbound Data Packet Flow in a Computer Network”, can be used to block certain packets before they reach a particular computer or network. A packet filtering firewall inspects the contents of the header of each packet received at the firewall and applies a set of rules to determine what should be done with the packet. As more rules are applied to the firewall, performance suffers and firewall maintenance increases. Furthermore, new viruses that have not yet been identified to a packet filtering firewall will not be detected.

Intrusion detection systems can be used to determine when a computer system is being comprised. U.S. Pat. No. 6,088,804 entitled “Adaptive System and Method for Responding to Computer Network Security Attacks”, describes one such system which uses agents and adaptive neural network technology to learn simulated attack signatures (e.g. virus patterns). A disadvantage of this system is that real attack signatures may not be similar to the simulated signatures and new signatures for which no training has been carried out may go completely undetected. Another system described in U.S. Pat. No. 5,892,903 entitled “Method and Apparatus for Detecting and Identifying Security Vulnerabilities in an Open Network Computer Communication System”, tests computers and network components for known vulnerabilities and provides reports for action by network management staff. However, this system requires a database of known vulnerabilities and detailed computer-system-specific descriptions of vulnerable components. Furthermore, these prior art system implementations depend upon operating system specific and packet content specific information to identify attack signatures on compromised computers.

There will always be Internet computer systems which are vulnerable to being compromised and which can be used to propagate viruses against other computer systems. In this constantly evolving environment, intrusion detection systems will naturally lag in detection capabilities. Encryption techniques and other stealth methods are routinely used by attack perpetrators to avoid detection of drone agents and the interception of communications between the malicious user, the master agents and the drone agents.

There is currently no easy method to discover the path from the target of an attack to the sources of the attack. Locating the source systems is a time-consuming process involving the detailed examination of system and router logs and extensive human communication and cooperation among the affected parties to exchange information. One system which attempts to address this issue is described in WO/01/46807. However, this system requires significant changes to router software and automated access to routers belonging to multiple Internet Service Providers (ISPs). This level of access is unlikely between competing ISPs.

Prior art in the field of network security and intrusion detection has focussed on examination of packet contents and higher level protocol analysis (for example, TCP layer connection handshaking and flow identification) to detect abnormal network data traffic. These systems and methods involve careful examination of all packets traversing a data link and require significant processing and memory resources as well as more complex configuration by network management personnel.

Other methods focus on detecting known viruses patterns.

The above methods fail to quickly detect the onset of malicious bandwidth use and are not capable of immediately detecting abnormal changes in network traffic, such as produced by low-level scanning, in an automatic or user controlled manner, which is independent of the upper layer network protocols used to mount the attack.

### SUMMARY OF THE INVENTION

In accordance with one aspect of the invention, there is provided a method of detecting self-propagation of a self-propagating program. The method involves producing difference values, each difference value representing a difference between volume of data traffic transmitted in a transmit direction and volume of data traffic received in a receive direction, in successive periods of time, incrementing an anomaly event counter when one of the difference values satisfies the difference criterion and setting an indicator active when the anomaly event counter reaches a value that meets a count criterion.

Producing the difference values may involve producing difference values having a magnitude that increases according to an amount by which the volume of data traffic transmitted in the transmit direction exceeds the volume of data traffic received in the receive direction.

Incrementing may involve determining whether or not the difference values satisfy the difference criterion.

Determining whether or not the difference values satisfy the difference criterion may involve determining whether or not the difference values exceed a threshold value.

Incrementing may involve incrementing the anomaly event counter when one of the difference values exceeds the threshold value.

The count criterion may involve a count threshold value.

Producing the difference values may involve receiving first and second data traffic waveforms representing respective time distributions of data volume in the transmit and receive directions in a period of time and producing the difference values from the first and second data traffic waveforms.

The method may involve generating the first and second traffic waveforms in response to first and second sets of traffic measurement values, representing traffic in the transmit and receive directions on the data communication system, respectively.

The first and second traffic waveforms may represent first and second statistical measures of first and second time distributions respectively of data volume in the transmit and receive directions in the data communications system.

Generating the first and second traffic waveforms may involve subjecting the first and second sets of traffic measurement values respectively, to a Discrete Wavelet Transform.

Subjecting the first and second sets of traffic measurement values to the Discrete Wavelet Transform may involve using Haar wavelet filter coefficients in the Discrete Wavelet Transform.

The method may involve causing the Discrete Wavelet Transform to produce a first component representing the first traffic waveform and a second component representing the second traffic waveform.

The method may involve determining whether the first and second components satisfy a correlation criterion and only incrementing the anomaly counter when the first and second components satisfy the correlation criterion.

The method may involve implementing a traffic waveform generator in a processor circuit used to produce the correlation value.

The method may involve monitoring data in the transmit and receive directions and producing the first and second sets of traffic measurement values respectively in response thereto.

Producing the first and second sets of traffic measurement values may involve producing values representing a property of an Ethernet statistics group in a remote monitoring protocol, for each of the transmit and receive directions.

The method may involve causing a processor circuit operable to produce the first and second traffic waveforms to communicate with a communication interface to receive the values representing a property of an Ethernet statistics group.

Monitoring the data in the transmit and receive directions may involve at least one of counting packets and counting octets in each of the transmit and receive directions.

The method may involve causing the processor circuit to implement at least one of the packet counter and the octet counter.

The method may involve signaling an operator when the status indicator is set active.

The method may involve controlling at least one of the transmission and reception of data from the data communication system when the status indicator is set active.

A computer readable medium may be encoded with codes for directing a processor circuit to perform.

A computer readable signal may be encoded with codes for directing a processor circuit to perform.

In accordance with another aspect of the invention, there is provided an apparatus for detecting self-propagation of a self-propagating program. The apparatus includes provisions for producing difference values, each difference value representing a difference between volume of data traffic transmitted in a transmit direction and volume of data traffic received in a receive direction, in successive periods of time. The apparatus further includes provisions for incrementing an anomaly event counter when one of the difference values satisfies the difference criterion, an indicator, and provisions for setting the indicator active when the anomaly event counter reaches a value that meets a count criterion.

The indicator may further include a memory location and the memory location may be set active when a pre-defined value is stored therein.

The provisions for producing the difference values may be operable to produce difference values having a magnitude that increases according to an amount by which the volume of data traffic transmitted in the transmit direction exceeds the volume of data traffic received in the receive direction.

The provisions for incrementing the anomaly event counter may be operable to determine whether or not the difference values satisfy the difference criterion.

The provisions for incrementing may be operable to determine whether or not the difference values exceed a threshold value.

The provisions for incrementing may be operable to increment the anomaly counter active when the difference values exceed the threshold value.

The count criterion may include a count threshold value.

The provisions for producing the difference values may include provisions for receiving first and second traffic waveforms representing respective time distributions of data volume in the transmit and receive directions in a period of time and the provisions for producing the difference values may be operable to produce the difference values in response to the first and second traffic waveforms.

The apparatus may further include a traffic waveform generator operable to receive first and second sets of traffic measurement values and to produce the first and second traffic waveforms in response thereto.

The first and second traffic waveforms may represent first and second statistical measures of first and second time distributions respectively of data volume in the transmit and receive directions respectively in the data communications system.

The traffic waveform generator may be configured to produce the first and second traffic waveforms by subjecting the first and second sets of traffic measurement values respectively, to a Discrete Wavelet Transform.

The traffic waveform generator may be configured to use Haar wavelet filter coefficients in the Discrete Wavelet Transform.

The traffic waveform generator may be configured to cause the Discrete Wavelet Transform to produce a first component, representing the first traffic waveform and a second component representing the receive traffic waveform.

The apparatus may further include provisions for correlating the first and second components to produce a correlation value and the provisions for incrementing may be operable to increment the anomaly event counter in response to the difference value only when the correlation value meets a correlation criterion.

The traffic waveform generator may include a processor circuit.

The apparatus may further include a communication interface operable to monitor data in the transmit and receive directions and to produce the first and second sets of traffic measurement values respectively in response thereto.

The communication interface may produce values representing a property of an Ethernet statistics group in a remote monitoring protocol, for each of the transmit and receive directions.

The apparatus may further include a processor circuit configured to communicate with the communication interface to receive the values representing a property of an Ethernet statistics group, for each of the transmit and receive directions, the values representing the first and second sets of traffic measurement values respectively.

The communication interface may include at least one of a packet counter and an octet counter operable to count a corresponding one of packets and octets of data for each of the transmit and receive directions.

The apparatus may further include a processor circuit configured to communicate with the communication interface to receive values produced by at least one of the packet counter and the octet counter, the values representing the first and second sets of traffic measurement values.

The apparatus may further include a processor circuit configured to implement the communication interface.

The apparatus may further include a passive monitor operable to passively monitor the data in the first and second directions and to provide copies of the data to the communication interface.

The apparatus may further include a signaling device for signaling an operator in response to the active indicator.

The apparatus may further include a communication control device for controlling at least one of the transmission and reception of data from the data communication system in response to the active indicator.

One benefit to detecting and subsequently neutralizing the propagating of a virus or worm is gained by blocking the outbound communications of systems infected with the virus or worm, preferably at the level of the individual computers infected with the virus or worm. The method and apparatus herein may be employed to monitor bandwidth in networks in which potentially infectable computers reside. Apparatus and methods according to the invention may be incorporated as a component of department-level Ethernet switches, routers or personal firewall hardware and firewall software, for example.

The system and method described below can quickly detect the onset of packet flooding and worm scanning and disable the sources of the packet flood, in an automatic or user-controlled manner, which is independent of the operating system used by the attacking computer or the target computer, and independent of the network protocols used to mount the attack.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings:

FIG. 1 is a schematic diagram of a data communication system employing an apparatus for detecting propagation of a self-propagating program, according to one embodiment of the invention;

FIG. 2 is a graphical representation of transmit and receive traffic volume in the data communication system;

FIG. 3 is a block diagram of a network subsystem of the communications system shown in FIG. 1;

FIG. 4 is a graph representing first and second waveforms representing a time distribution of data volume in transmit and receive directions on the data communication system of FIG. 1 for normal data;

FIG. 5 is a block diagram of a processor circuit according to one embodiment of the invention;

FIGS. 6A and 6B are a flow diagram of a method executed by the processor circuit shown in FIG. 5.

### DETAILED DESCRIPTION

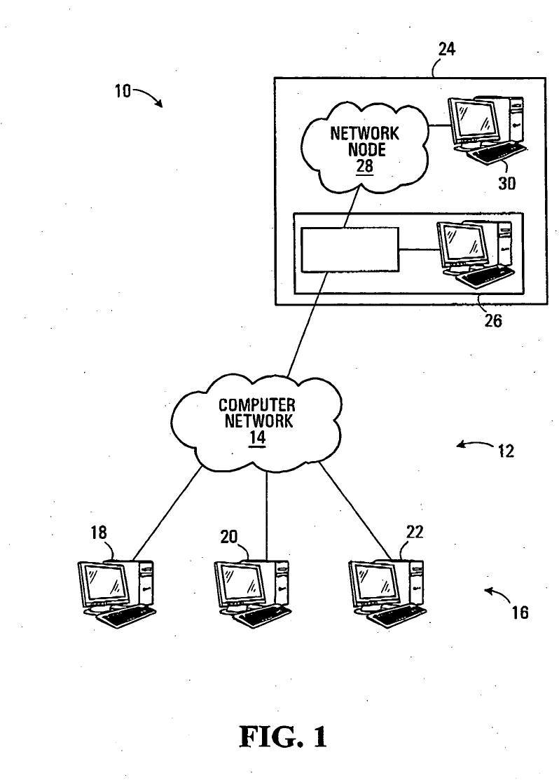

Referring to FIG. 1, a system according to a first embodiment of the invention is shown generally at 10. The system includes a network of computers shown generally at 12 comprising a data communication system 14 such as an Intranet or Internet, and a plurality of nodes shown generally at 16 including networked devices such as, for example, a personal computer 18, a first server computer 20, a second server computer 22 and a network sub-system shown at 24. In this embodiment, the network subsystem includes a self-propagating program detector apparatus shown generally at 26 and a network node 28 which may include a sub-network and/or any of a plurality of devices which would normally be connected to a computer network. Such devices may include, but are not limited to server computers, client computers, routers, bridges, multi-port bridges (Ethernet switches), hubs, ATM switches, and wireless access points for example. The data communication system 14 may be local to a site thereby representing a Local Area Network (LAN) or may be global, for example, such as the Internet.

During the normal operation of the system 10 the networked devices 16 communicate with one another. For example, the client computer 18 may communicate with the server computers 20 or 22 or other client computers connected to the data communication system 14. In all cases, communication between the networked devices 16 involves the use of several data transfer protocols. These protocols may be classified, for example, according to the OSI 7-layer model of network protocols. The protocols may include protocols from the TCP/IP protocol suite, for example.

A typical interaction between a client computer 18 and a server computer 30 such as a World Wide Web server associated with the network sub-system 24 involves the client computer 18 initiating a protocol connection with the server computer 30, i.e., in the transmit and receive directions relative to the server computer 30. This is followed by a plurality of data packet transfers between the client computer 18 and the server computer 30. Eventually the protocol connection is terminated by either the client computer 18 or the server computer 30. A plurality of such protocol connections between a plurality of client computers and a plurality of server computers results in an aggregation of packet transfers on the network. A detailed description of this process for the TCP/IP protocol suite is found in Stallings High-speed Networks: TCP/IP and ATM Design Principles, Prentice-Hall, 1998. In general, each networked device transmits data packets to the data communication system 14 for transmission to another networked device and each networked device is operable to receive from the data communication system 14 data packets originating at another networked device.

A characteristic of traffic on networks in which devices exchange data by establishing protocol connections with one another is that packets are transmitted in bursts onto the network. Measurements of the patterns of these bursts of packets have shown them to be fractal or self-similar in nature. That is, the pattern of packet or byte counts observed at a particular measurement point on the network and aggregated at different sampling time scales (for example: at every 1 millisecond, 10 milliseconds, 1 second, or 10 seconds) is similar at each of these time scales.

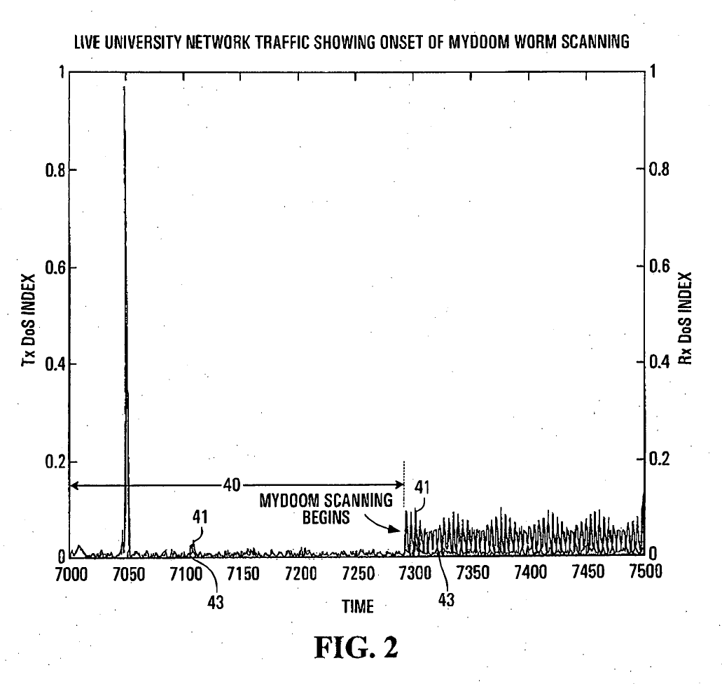

Normal communications conducted by one networked device with another networked device on the data communication system 14 normally appears “bursty” and balanced in the transmit and receive directions. Bandwidth anomalies such as those which occur due to a virus attempting to propagate itself appear as an excess of traffic in the transmit direction compared to the traffic in the receive direction. An example of normal communications in the transmit and receive directions at a client computer 18 is shown generally at 40 in FIG. 2. Traffic in the transmit direction is depicted by trace 41 and traffic in the receive direction is depicted by trace 43. These two traces 41 and 43 are nearly identical and are almost perfectly aligned. When a virus such as the 2004 MyDoom virus infiltrates the client computer 18, the transmit trace 41 shows an increase in transmit traffic while the receive trace 43 shows a relatively consistent traffic volume whether or not the virus has infiltrated the computer 18.

Referring back to FIG. 1, in the embodiment shown, the apparatus 26 is used to produce difference values, each difference value representing a difference between volume of data traffic transmitted in a transmit direction and data traffic received in a receive direction, in successive periods of time, increment an anomaly event counter when one of the difference values satisfies a difference criterion and set an indicator active when the anomaly event counter reaches a value that meets a count criterion. This indicator may be used to actuate a signaling device for signaling an operator and/or it may be used to actuate a communication control device for controlling the transmission of data from the computer in response to the active indicator.

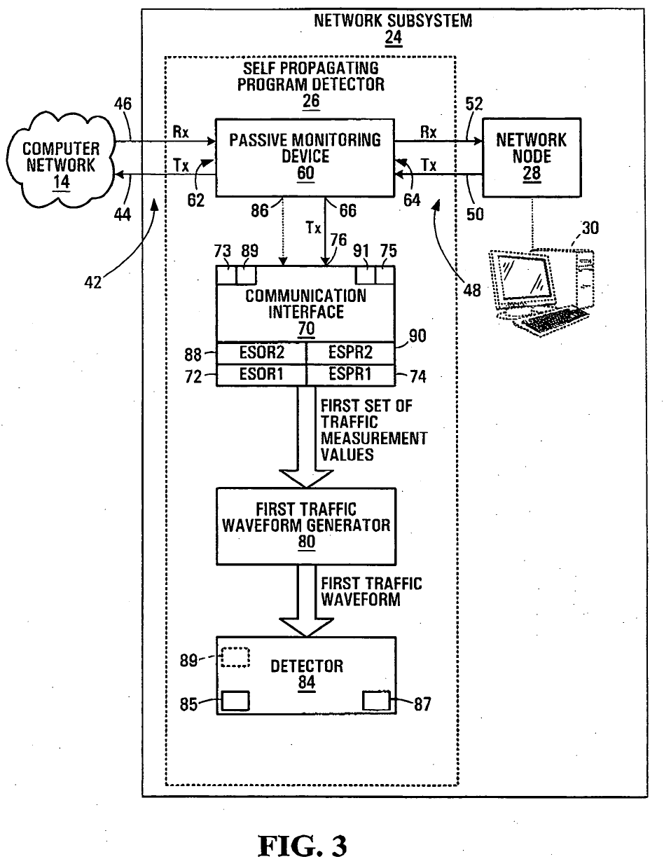

An embodiment of an exemplary self-propagating program detector apparatus is shown at 26 in FIG. 3 and is depicted as a separate device in this embodiment, interposed between the data communication system 14 and the network node 28. The apparatus 26 may be located anywhere in the data communication system 14 where it can sample data traffic being transmitted between any two networked devices. However, a benefit may be obtained when the apparatus 26 is located at or near the edge of the network, for example with Ethernet switches in a department-level communications room.

For explanatory purposes, a link 42 between the data communication system 14 and the self-propagating program detector 26 is depicted as having a first transmit data line 44 and a first receive data line 46. Similarly, a second link 48 is provided between the self-propagating program detector 26 and the network node 28 and includes a second transmit data line 50 and a second receive data line 52. The first receive data line 46 receives data from the data communication system 14 destined for the network node 28. The second transmit data line 50 carries data transmitted by the network node 28 destined for the data communication system 14.

In this embodiment, data travelling on the transmit data lines 44 and 50 is considered to be travelling in a first (transmit) direction on the network and data travelling on receive data lines 46 and 52 is considered to be travelling in a second (receive) direction.

The self-propagating program detector 26 is shown as a separate device but may be incorporated into an apparatus which itself acts as a network node. For example, the self-propagating program detector 26 may be incorporated into a router, bridge, multi-port bridge, hub, wireless access point, cable/DSL modem, firewall, Internet, telephone, PDA, cellular phone or ATM switch, for example.

In this embodiment, the self-propagating program detector 26 includes a passive monitoring device 60 having network side link connections 62 for connection to the first link 42 and having node side connections 64 for connecting to the network node 28. The passive monitoring device 60 also has outputs, 66 and 86, which are operable to supply copies of each data unit appearing on the transmit line 50 and receive line 52, respectively. The passive monitoring device 60 simply taps off a copy of the data packets in each direction. In general, the passive monitoring device 60 may be said to passively monitor data in the transmit and receive directions and to make copies of the data packets in the transmit and receive directions available to another device. A typical passive monitoring device that may be used in this application is provided by Net Optics Corporation of Sunnyvale, Calif.

The self-propagating program detector 26 further includes a communication interface 70 which may include a network interface chip such as an Ethernet interface chip, switch processor, or security processor, for example. Alternatively, the communication interface 70 may be implemented by other components including discrete logic circuits and/or processor circuits, for example.

In this embodiment, the communication interface 70 includes an Ethernet interface chip having registers operable to provide values in accordance with a property of an Ethernet statistics group of an Ethernet remote monitoring protocol standard such as set forth in the Internet Engineering Task Force RFC #3144. In particular, the communication interface 70 includes at least one of an octets register 72 and a packets register 74 of an octet counter 73 and a packet counter 75. The communication interface 70 has an input 76 in communication with the output 66 of the passive monitoring device 60 to receive copies of the data units on the transmit data line 50 and keeps a count of these data units and determines from the data units the number of octets and the number of packets associated with such data units over a specified period of time which will be referred to herein as a sample time. In this embodiment, the communication interface 70 is set to count the number of octets and packets on the transmit data line 50 during successive 1/1024 second intervals and at the end of each interval, load the octets register 72 and the packets register 74 with associated count values. Thus, each 1/1024 second a new count value is available in the octets register 72 and in the packets register 74. Thus, the communication interface 70 serves to monitor data in the transmit direction by sampling data on the transmit line to produce traffic measurement values. A plurality of these traffic measurement values gathered over a period of time or window, such as 120 seconds, for example, may be referred to as a first set of traffic measurement values.

The passive monitoring device 60 is configured to have a second output 86 operable to provide copies of data units appearing on the receive data line 46 to the communication interface 70. In addition, the communication interface 70 is configured with a second Ethernet statistics octet register 88 and a second Ethernet statistics packet register 90 of an octet counter 89 and a packet counter 91 for holding count values representing the number of octets and the number of packets, respectively, on the receive data line 46 in a given 1/1024^{th} of a second, that is, during the same time period during which octets and packets in the transmit direction are counted.

The traffic measurement values produced by monitoring the receive data line 46 may be accumulated into a second set of traffic measurement values.

The self-propagating program detector 26 further comprises a traffic waveform generator 80 operable to receive the first and second sets of traffic measurement values and to produce first and second traffic waveforms representing a time distribution of data volume in the transmit and receive directions respectively, in response thereto. The traffic waveform generator 80 is configured to produce the first and second traffic waveforms by subjecting the first and second sets of traffic measurement values respective to separate operations of a Discrete Wavelet Transform to perform a wavelet analysis on the respective sets of traffic measurement values.

Wavelet analysis allows for the detection of abrupt changes in frequency across a range of time scales. The Discrete Wavelet Transform involves the application of a series of successive low- and high-pass filtering operations using a selected wavelet function to produce approximation and detail components of the original data traffic signal. One example wavelet function which may be used for this purpose in the present invention is the Haar Wavelet. Commercial software packages including the MATLAB Wavelet Toolbox and User's Guide provide utilities for general purpose analysis of signals with the Discrete Wavelet Transform.

Various different coefficients may be used in the Discrete Wavelet Transform and it has been found that in this embodiment using Haar wavelet filter coefficients in the Discrete Wavelet Transform causes the traffic waveform generator 80 to produce smooth and detail waveform components of the first and second sets of traffic measurement values. In this embodiment, only the smooth components are of interest and such smooth components are used to represent the first and second traffic waveforms.

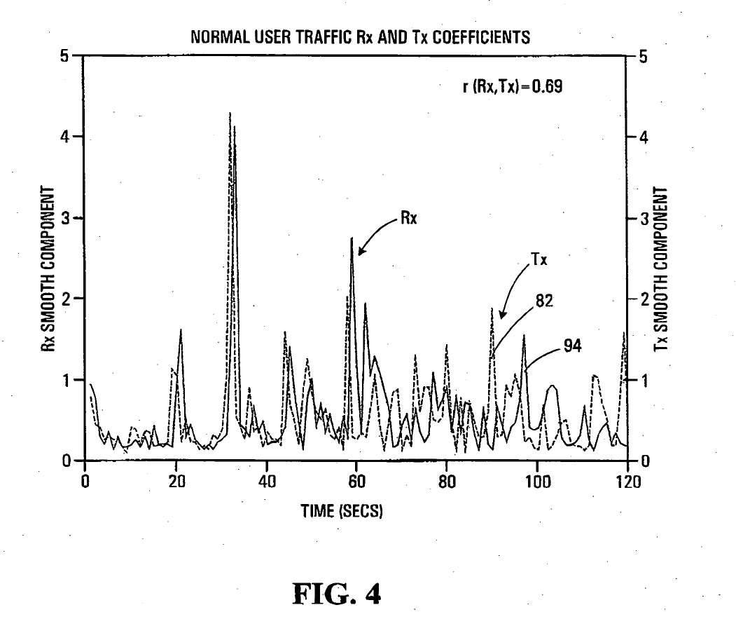

Referring to FIG. 4, the smooth components of the first and second traffic waveforms are seen as a plot of an amplitude value versus time as shown in broken outline at 82 and 94 over a 120 second time interval. The traffic waveform generator 80 shown in FIG. 3 represents the first and second traffic waveforms as sets of amplitude values associated with respective times in the 120 second window in which samples are taken, to produce the first and second sets of traffic measurement values. Thus, the first and second traffic waveforms represent a time distribution of data volume in the transmit and receive directions in the data communication system in a first period of time.

Referring back to FIG. 3, the self-propagating program detector 26 further includes a detector 84 for detecting differences between the volume of data traffic transmitted in the transmit direction and the volume of data traffic received in the receive direction. This detector 84 is operable to receive the first and second traffic waveform smooth components and produces difference values representing the difference in data volume in successive periods of time. When the difference value satisfies a difference criterion, an anomaly event counter 85 therein is incremented and when the anomaly event counter reaches a value that meets a count criterion, an indicator 87 is set active, such as by loading a pre-defined value into a memory location, for example.

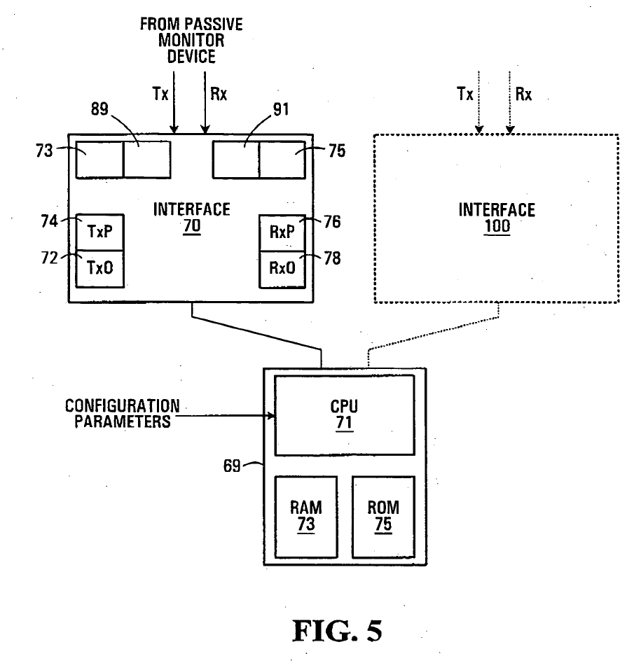

Referring to FIGS. 3 and 5, the detector 84 may be implemented in a processor circuit 69 which may be part of a personal computer system, for example. The processor circuit may include a CPU 71, RAM 73, and ROM 75 and may further include the communication interface 70, for example. Alternatively, the processor circuit 69 may be that of a switch, router, bridge or any other apparatus connectable to the data communication system. The same processor circuit 69 that implements the detector 84 may be used to implement the traffic waveform generator 80 and the communication interface 70. Alternatively, any combination of the communication interface 70, traffic waveform generator 80 and detector 84 may be implemented using a wide variety of different processor circuit combinations.

Optionally, the processor circuit 69 implementing the detector 84 may also be configured with a correlator 89, to produce a correlation value representing the correlation between the smooth components representing the first and second waveforms and to determine whether the correlation value it produces satisfies a correlation criterion, such as whether or not the correlation value is less than a reference value and to permit the anomaly event counter 85 to be incremented only when the correlation value is less than this reference value.

Given the first and second traffic waveforms, the correlator 89 may produce a correlation value such as the value 0.69 shown in FIG. 4 representing the correlation of the first and second traffic waveforms and more particularly, the correlation of the transmit waveform with the receive waveform. The detector may then determine whether this correlation value 0.69 is above a predefined value such as 0.6 and, if so, prevent the anomaly event counter 85 from being incremented in view of the good correlation between transmit and receive data volume over the same time period and therefore no self-propagation is likely to be occurring.

If, however, the first and second traffic waveforms produce a correlation value such as 0.12, the detector 84 will determine that this correlation value is less than the 0.6 pre-defined value and therefore will permit the anomaly event counter 85 to be incremented to indicate that a correlation consistent with an excess of packets in the transmit direction has been found. Additional criteria for incrementing the anomaly event counter 85 may be employed, such as determining whether the correlation value is sustained at a value less than the reference value for a period of time, or whether a number of occurrences of a correlation value less than the reference value happen over a period of time, for example.

When the anomaly event counter 85 reaches a value that meets a count criterion, the indicator 87 is set active.

Referring back to FIG. 3, an active indicator 87 may be used to interrupt a processor circuit in a switch or the network node 28, for example, to cause the switch or network node 28 to be denied access to the data communication system 14 to stop the unusual transmission of packets. Alternatively or in addition, the active indicator 87 may be detected and used to initiate programs for actuating an alarm, blinking a light, sounding an audible signal or activating any other stimulus recognizable by an operator to indicate to the operator that a virus may have infiltrated the system.

Referring to FIG. 5, an alternative implementation of the system described herein may be implemented with a different interface 100. This interface 100 may simply provide a path to the processor circuit 69, for the data units received from the passive monitoring device (60) and the processor circuit 69 itself may be used to perform counting functions to count the number of packets and/or octets appearing on the transmit and receive lines in a given sample interval. Code for directing the processor circuit 69 to carry out these functions may be provided to the processor circuit as computer readable instructions supplied on a computer-readable medium such as an EPROM, which may form part of the ROM 75, or may be supplied to the processor circuit 69 on a Compact or Floppy disk, for example and stored in programmable ROM which may also form part of the ROM 75. Alternatively or in addition, the codes for directing the processor circuit 69 to carry out functions according to an embodiment of the invention may be supplied to the processor circuit by way of a computer readable signal encoded with such codes, such as may be provided by reading data packets received on the receive line, for example.

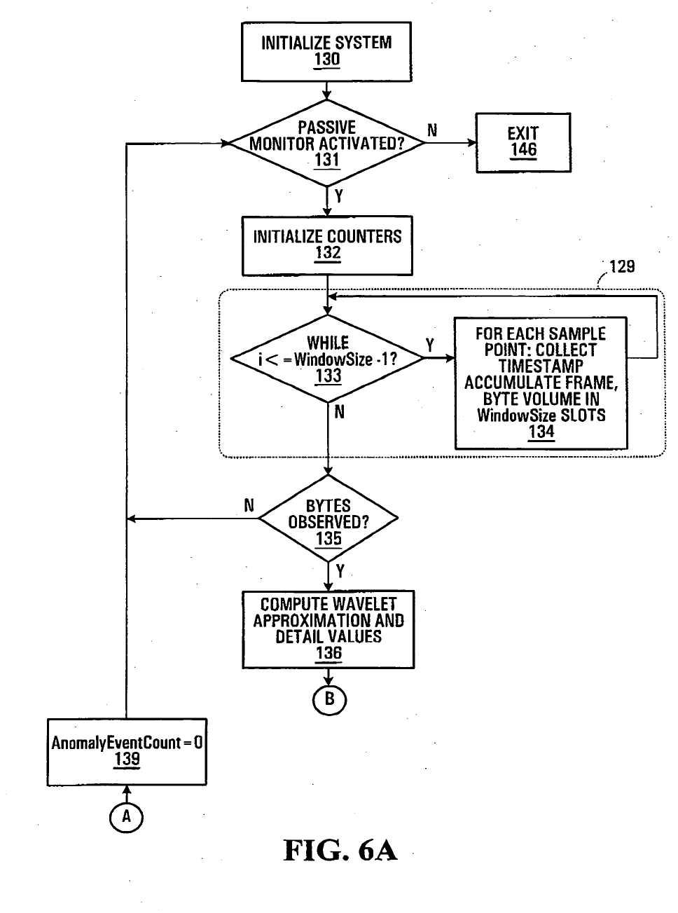

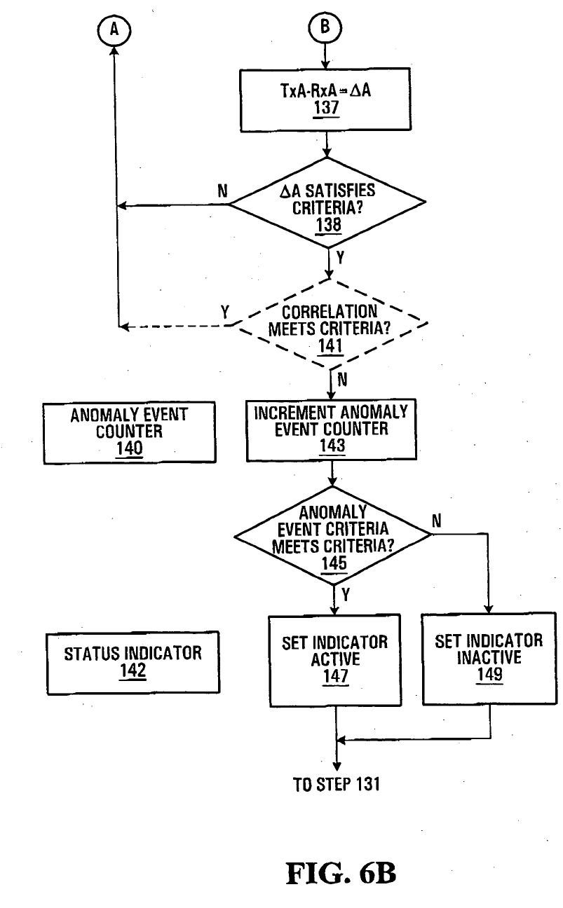

A flowchart containing blocks indicative of blocks of code that may be used to implement this alternative embodiment of the invention is depicted in FIGS. 6A and 6B. The actual code used to implement the functionality indicated in any given block may be written in the C, C++ and/or assembler code, for example.

In this embodiment, the processor circuit 69 is first directed by block 130 to initialize various counters and registers including octet and packet count registers, arrays, indices, status indicators, flags, control registers. Block 131 then directs the processor circuit 69 to communicate with the passive monitoring device 60 to determine whether or not the passive monitoring device is operating to passively monitor packets on the transmit and receive lines. If it is not, the process is ended.

If the passive monitoring device 60 is operational, block 132 directs the processor circuit 69 to initialize counters.

Then block 129 directs the processor circuit 69 to fill first and second arrays with first and second sets of traffic measurement values. To do this, block 129 includes two main functional blocks which cooperate to implement a loop to fill the arrays. The first functional block 133 directs the processor circuit 69 to determine whether an index value i is less than or equal to a reference value calculated as a pre-defined value, WindowSize−1, where WindowSize refers to the number of elements in the first and second sets of traffic data. This value is desirably a power of 2. Ultimately, the WindowSize value represents the length of a period of acquisition of the first and second sets of traffic data.

Block 134 directs the processor circuit 69 to acquire and store in the first and second arrays current packet or octet counter values and associated timestamp values for the transmit and receive lines, increments the index i and returns the processor to block 133. Thus, the first and second arrays are arrays of pairs of numbers, the first number indicating a time interval or bin to which the counter value relates and the second number indicating the counter value associated with that time interval or bin. The first and second arrays may be referred to as first and second PacketVectors having a length of WindowSize.

Block 135 directs the processor circuit 69 to read the first and second arrays to determine whether all of the values in the arrays are zero. If so, the processor circuit is directed back to block 131 to determine whether the passive monitor is still activated and to re-start the gathering of count values.

Block 136 implements the waveform generator function described above and directs the processor circuit 69 to subject the first and second PacketVectors to wavelet analysis using the Discrete Wavelet Transform, to produce an approximation value and detail values for each of the transmit and receive directions. Approximation values represent high-scale, low-frequency components of data traffic measurements. High-scale refers to the “stretching” of the wavelet used to filter the signal so as to view the data traffic measurements over a longer time window. Detail values represent low-scale, high-frequency components of the input data traffic measurements. Low-scale refers to the “compressing” of the wavelet used to filter the data traffic measurements so as to view the data traffic measurements over a short time window.

Referring to FIG. 6B, block 137 then directs the processor circuit 69 to compute an approximation difference value representing the difference between the transmit approximation value and the receive approximation value.

Block 138 then directs the processor circuit to determine whether the approximation difference value satisfies an approximation criterion, such as whether or not the approximation difference value exceeds a pre-defined value

If at block 138, the approximation difference value does not satisfy the approximation criterion, the processor circuit is directed to block 139 of FIG. 6A which directs the processor circuit to set an anomaly event counter 140 in the RAM 73 to zero and then return to block 131 to continue monitoring the transmit and receive traffic.

If at block 138 in FIG. 6B, the approximation difference value satisfies the approximation criterion, the processor circuit is directed to block 143 which directs the processor circuit to increment the anomaly event counter 140.

Optionally, before incrementing the anomaly event counter, the processor circuit may be directed to block 141 which directs the processor circuit to produce a correlation value using the method described above, representing the correlation between the first (transmit) traffic waveform and the second (receive) traffic waveform, and to determine whether or not the correlation value satisfies a correlation criterion such as whether or not the correlation value exceeds a pre-defined correlation value. If the correlation criterion is satisfied, the processor is directed to block 139 to reset the event counter to zero and resume monitoring the transmit and receive traffic. If the correlation criterion is not satisfied, the processor is directed to block 143 to increment the anomaly event counter.

In correlating the fluctuations of the approximation and detail values for the transmit and receive lines, it is not necessary that the transmit and receive data be measured at identical times. Since the approximation and detail values are smoothed values, correlations can be detected even if the data is not measured simultaneously. However, data count value samples for the transmit and receive lines should be taken at times which are close enough to one another to detect correlations in these smoothed values during normal network traffic activity.

Block 145 then directs the processor circuit to determine whether the anomaly event counter value meets an event counter criterion, such as whether or not the event counter value exceeds a threshold value and if so, to proceed to block 147, which directs the processor circuit to set a status indicator 142 in the RAM 73 to true, the processor circuit is then directed to block 139 of FIG. 6A to reset the anomaly event counter 140 to zero.

If at block 145 of FIG. 6B the processor circuit determines that the anomaly event counter value does not meet the event counter criterion the processor is directed to block 149 which causes it to set the status indicator 142 to false and then the processor circuit is directed to block 139 of FIG. 6A which causes the processor circuit to reset the anomaly event counter 140 to zero.

The wide-spread use of the invention would reduce the impact of packet flood denial of service attacks and Internet worms by mitigating these attacks at the earliest stages, and as well, providing critical attack source identification information to network management staff such that compromised systems could be quickly located and secured against future compromise. The method and apparatus described herein overcomes the current inadequacy of existing detection systems in identifying a link which carries packet flooding/scanning traffic. One of the principle difficulties in prior art is that high levels of link utilization can be common for normal traffic patterns. However, disabling a link or limiting the bandwidth on a link when utilization is high because it is believed that malicious packet flooding is occurring could lead to significant disruptions of legitimate network activity. The use of burstiness measures i.e., wavelet analysis and/or approximate values in the present invention provides a way of distinguishing abnormal traffic patterns and utilization patterns from normal network traffic, without examining packet content.

While specific embodiments of the invention have been described and illustrated, such embodiments should be considered illustrative of the invention only and not as limiting the invention as construed in accordance with the accompanying claims.

1. A method of detecting self propagation of a self-propagating program, the method comprising:
producing difference values, each difference value representing a difference between volume of data traffic transmitted in a transmit direction and volume of data traffic received in a receive direction, in successive periods of time;
incrementing an anomaly event counter when one of said difference values satisfies said difference criterion; and
setting an indicator active when said anomaly event counter reaches a value that meets a count criterion.

2. The method of claim 1 wherein producing said difference values comprises producing difference values having a magnitude that increases according to an amount by which the volume of data traffic transmitted in said transmit direction exceeds the volume of data traffic received in said receive direction.

3. The method of claim 2 wherein incrementing comprises determining whether or not said difference values satisfy said difference criterion.

4. The method of claim 3 wherein determining whether or not said difference values satisfy said difference criterion comprises determining whether or not said difference values exceed a threshold value.

5. The method of claim 4 wherein incrementing comprises incrementing said anomaly event counter when one of said difference values exceeds said threshold value.

6. The method of claim 1 wherein said count criterion comprises a count threshold value.

7. The method of claim 1 wherein producing said difference values comprises receiving first and second data traffic waveforms representing respective time distributions of data volume in said transmit and receive directions in a period of time and producing said difference values from said first and second data traffic waveforms.

8. The method of claim 7 further comprising generating said first and second traffic waveforms in response to first and second sets of traffic measurement values, representing traffic in said transmit and receive directions on said data communication system, respectively.

9. The method of claim 8 wherein said first and second traffic waveforms represent first and second statistical measures of first and second time distributions respectively of data volume in said transmit and receive directions in said data communications system.

10. The method of claim 8 wherein generating said first and second traffic waveforms comprises subjecting said first and second sets of traffic measurement values respectively, to a Discrete Wavelet Transform.

11. The method of claim 10 wherein subjecting said first and second sets of traffic measurement values to said Discrete Wavelet Transform comprises using Haar wavelet filter coefficients in said Discrete Wavelet Transform.

12. The method of claim 10 further comprising causing said Discrete Wavelet Transform to produce a first component, representing said first traffic waveform and a second component representing said second traffic waveform.

13. The method of claim 12 further comprising determining whether said first and second components satisfy a criterion and only incrementing said anomaly counter when said first and second components satisfy a correlation criterion.

14. The method of claim 12 further comprising implementing a traffic waveform generator in a processor circuit used to produce said correlation value.

15. The method of claim 8 further comprising monitoring data in said transmit and receive directions and producing said first and second sets of traffic measurement values respectively in response thereto.

16. The method of claim 15 wherein producing said first and second sets of traffic measurement values comprises producing values representing a property of an Ethernet statistics group in a remote monitoring protocol, for each of said transmit and receive directions.

17. The method of claim 16 further comprising causing a processor circuit operable to produce said first and second traffic waveforms to communicate with a communication interface to receive said values representing a property of an Ethernet statistics group.

18. The method of claim 15 wherein monitoring said data comprises at least one of counting packets and counting octets in each of said transmit and receive directions.

19. The method of claim 18 further comprising causing said processor circuit to implement at least one of said packet counter and said octet counter.

20. The method of claim 1 and further comprising signaling an operator when said status indicator is set active.

21. The method of claim 1 and further comprising controlling at least one of the transmission and reception of data from said data communication system when said status indicator is set active.

22. A computer readable medium encoded with codes for directing a processor circuit to perform the method of claim 1.

23. A computer readable signal encoded with codes for directing a processor circuit to perform the method of claim 1.

24. An apparatus for detecting self-propagation of a self-propagating program, the apparatus comprising:
means for producing difference values, each difference value representing a difference between volume of data traffic transmitted in a transmit direction and volume of data traffic received in a receive direction, in successive periods of time;
means for incrementing an anomaly event counter when one of said difference values satisfies said difference criterion;
an indicator; and
means for setting said indicator active when said anomaly event counter reaches a value that meets a count criterion.

25. The apparatus of claim 24 wherein said indicator comprises a memory location and wherein said memory location is set active when a pre-defined value is stored therein.

26. The apparatus of claim 24 wherein said means for producing said difference values is operable to produce difference values having a magnitude that increases according to an amount by which the volume of data traffic transmitted in said transmit direction exceeds the volume of data traffic received in said receive direction.

27. The apparatus of claim 26 wherein said means for incrementing said anomaly event counter is operable to determine whether or not said difference values satisfy said difference criterion.

28. The apparatus of claim 26 wherein said means for incrementing is operable to determine whether or not said difference values exceed a threshold value.

29. The apparatus of claim 28 wherein said means for incrementing is operable to increment said anomaly counter active when said difference values exceed said threshold value.

30. The apparatus of claim 24 wherein said count criterion comprises a count threshold value.

31. The apparatus of claim 24 wherein said means for producing said difference values comprises means for receiving first and second traffic waveforms representing respective time distributions of data volume in said transmit and receive directions in a period of time and wherein said means for producing said difference values is operable to produce said difference values in response to said first and second traffic waveforms.

32. The apparatus of claim 31 further comprising a traffic waveform generator operable to receive first and second sets of traffic measurement values and to produce said first and second traffic waveforms in response thereto.

33. The apparatus of claim 32 where said first and second traffic waveforms represent first and second statistical measures of first and second time distributions respectively of data volume in said transmit and receive directions respectively in said data communications system.

34. The apparatus of claim 32 wherein said traffic waveform generator is configured to produce said first and second traffic waveforms by subjecting said first and second sets of traffic measurement values respectively, to a Discrete Wavelet Transform.

35. The apparatus of claim 34 wherein said traffic waveform generator is configured to use Haar wavelet filter coefficients in said Discrete Wavelet Transform.

36. The apparatus of claim 34 wherein said traffic waveform generator is configured to cause said Discrete Wavelet Transform to produce a first component, representing said first traffic waveform and a second component representing said receive traffic waveform.

37. The apparatus of claim 36 further comprising means for correlating said first and second components to produce a correlation value and where said means for incrementing is operable to increment said anomaly event counter in response to said difference value only when said correlation value meets a correlation criterion.

38. The apparatus of claim 36 wherein said traffic waveform generator includes a processor circuit.

39. The apparatus of claim 32 further comprising a communication interface operable to monitor data in said transmit and receive directions and to produce said first and second sets of traffic measurement values respectively in response thereto.

40. The apparatus of claim 39 wherein said communication interface produces values representing a property of an Ethernet statistics group in a remote monitoring protocol, for each of said transmit and receive directions.

41. The apparatus of claim 40 further comprising a processor circuit configured to communicate with said communication interface to receive said values representing a property of an Ethernet statistics group, for each of said transmit and receive directions, said values representing said first and second sets of traffic measurement values respectively.

42. The apparatus of claim 39 wherein said communication interface includes at least one of a packet counter and an octet counter operable to count a corresponding one of packets and octets of data for each of said transmit and receive directions.

43. The apparatus of claim 39 further comprising a processor circuit configured to communicate with said communication interface to receive values produced by at least one of said packet counter and said octet counter, said values representing said first and second sets of traffic measurement values.

44. The apparatus of claim 39 further comprising a processor circuit configured to implement said communication interface.

45. The apparatus of claim 39 further comprising a passive monitor operable to passively monitor said data in said first and second directions and to provide copies of said data to said communication interface.

46. The apparatus of claim 24, further comprising a signaling device for signaling an operator in response to said active indicator.

47. The apparatus of claim 24, further comprising a communication control device for controlling at least one of the transmission and reception of data from said data communication system in response to said active indicator.
